(19) United States
(12) Patent Application Publication
(10) Pub. No.: US 2025/0203566 A1
(43) Pub. Date: Jun. 19, 2025

(54) DEVICE RANGING USING MULTIPLE ACCESS POINTS

(71) Applicant: Cisco Technology, Inc., San Jose, CA (US)

(72) Inventors: Laurent A. PIERRUGUES, San Jose, CA (US); Jerome HENRY, Pittsboro, NC (US)

(21) Appl. No.: 18/942,218

(22) Filed: Nov. 8, 2024

Related U.S. Application Data
(60) Provisional application No. 63/612,300, filed on Dec. 19, 2023.

(51) Int. Cl. H04W 64/00; H04L 5/00

(52) U.S. Cl. CPC H04W 64/00; H04L 5/0053

(57) ABSTRACT

The present disclosure describes a device that initiates ranging with multiple access points simultaneously using different radios. The device includes a first radio and a second radio. The device transmits, at a first time and using the first radio, a message to a first access point, transmits, at the first time and using the second radio, the message to a second access point different from the first access point, receives, at a second time after the first time and from the first access point, a first response to the message, receives, at a third time after the first time and from the second access point, a second response to the message, and determines, based on the second time and the third time, a location of the device.

### CROSS-REFERENCE TO RELATED APPLICATIONS

This application claims benefit of co-pending U.S. provisional patent application Ser. No. 63/612,300 filed Dec. 19, 2023. The aforementioned related patent application is herein incorporated by reference in its entirety.

### TECHNICAL FIELD

Embodiments presented in this disclosure generally relate to wireless communication. More specifically, embodiments disclosed herein relate to device ranging using multiple access points.

### BACKGROUND

A device may perform wireless ranging with an access point to determine an approximate location of the device. For example, the device may send a message to the access point and receive a response to the message from the access point. The device may use the time of flight for the message and the response and the location of the access point to determine the location of the device. Exiting ranging processes, however, may provide limited accuracy and may provide limited insight into the positioning of the device (e.g., the orientation or alignment of the device).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example access point or device in the system of FIG. 1A.

FIG. 2 illustrates an example operation performed by the system of FIG. 1A.

FIG. 3 illustrates an example operation performed by the system of FIG. 1A.

FIG. 4 illustrates an example operation performed by the system of FIG. 1A.

FIG. 5 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a device that initiates ranging with multiple access points simultaneously using different radios. According to an embodiment, the device includes a first radio, a second radio, one or more memories, and one or more processors communicatively coupled to the one or more memories. The one or more processors, individually or collectively transmit, at a first time and using the first radio, a message to a first access point, transmit, at the first time and using the second radio, the message to a second access point different from the first access point, receive, at a second time after the first time and from the first access point, a first response to the message, receive, at a third time after the first time and from the second access point, a second response to the message, and determine, based on the second time and the third time, a location of the device.

According to another embodiment, a method includes transmitting, at a first time and using a first radio of a device, a message to a first access point, transmitting, at the first time and using a second radio of the device, the message to a second access point different from the first access point, receiving, at a second time after the first time and from the first access point, a first response to the message, receiving, at a third time after the first time and from the second access point, a second response to the message, and determining, based on the second time and the third time, a location of the method.

According to another embodiment, a non-transitory computer readable medium stores instructions that, when executed by one or more processors, causes the one or more processors to, individually or collectively, transmit, at a first time and using a first radio of a device, a message to a first access point, transmit, at the first time and using a second radio of the device, the message to a second access point different from the first access point, receive, at a second time after the first time and from the first access point, a first response to the message, receive, at a third time after the first time and from the second access point, a second response to the message, and determine, based on the second time and the third time, a location of the device.

### Example Embodiments

The present disclosure describes a device that initiates wireless ranging with multiple access points simultaneously using multiple radios. For example, the device uses a first radio to transmit a message to a first access point and a second radio to transmit the message to a second access point to initiate ranging with both access points simultaneously. The device then waits for the responses from the access points and may receive those responses at different times. The device uses the times at which the device received the responses (e.g., the differential time) to determine a location of the device.

In certain embodiments, this ranging technique provides several technical advantages. For example, the location determined by the device may be more accurate relative to locations determined using existing ranging techniques (e.g., ranging involving only one access point). As another example, the ranging technique may provide additional insight, such as the orientation or alignment of the device.

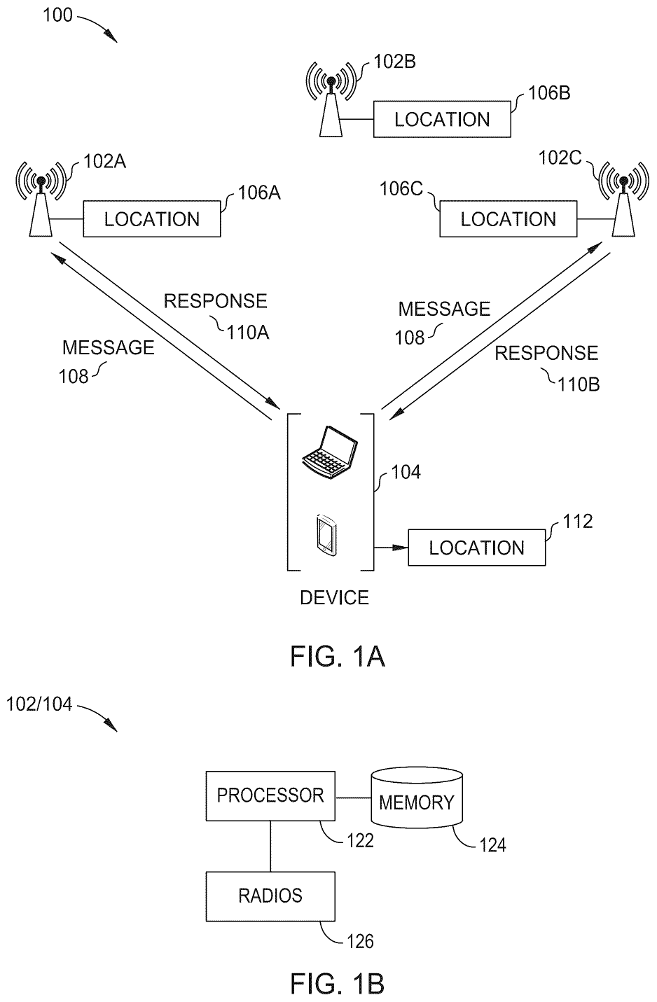

FIG. 1A illustrates an example system 100. As seen in FIG. 1A, the system 100 includes multiple access points 102 and one or more devices 104. Generally, the device 104 initiates ranging with multiple access points 102 using multiple radios. In this manner, the device 104 may determine a location of the device 104 with improved accuracy relative to existing ranging techniques.

The access points 102 facilitate wireless communication (e.g., Wi-Fi communication) in the system 100. The device 104 may connect to an access point 102. The access point 102 may then facilitate wireless communication for the connected device 104. In the example of FIG. 1A, the system 100 includes the access points 102A, 102B, and 102C. The access points 102A, 102B, and 102C may be positioned in and serve different locations. For example, the access points 102A, 102B, and 102C may be positioned in different areas or different floors of a building. The access points 102A, 102B, and 102C may be provided their respective locations 106A, 106B, and 106C. For example, when the access points 102A, 102B, and 102C are installed, the access points 102A, 102B, and 102C may be provisioned with coordinates indicating their locations 106A, 106B, and 106C. As another example, the access points 102A, 102B, and 102C may include geolocation systems (e.g., global positioning systems) that provide the locations 106A, 106B, and 106C.

The access points 102A, 102B, and 102C may provide the locations 106A, 106B, and 106C (e.g., as coordinates) to the device 104. For example, the access points 102A, 102B, and 102C may provide the locations 106A, 106B, and 106C when the device 104 probes or connects to the access points 102A, 102B, and 102C. As another example, the access points 102A, 102B, and 102C may provide the locations 106A, 106B, and 106C when the device 104 initiates ranging with the access points 102A, 102B, and 102C. In this manner, the access points 102A, 102B, and 102C inform the device 104 of the locations 106A, 106B, and 106C of the access points 102A, 102B, and 102C.

The device 104 may be any suitable device that wirelessly connects to the access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

In operation, the device 104 performs ranging by communicating a message 108 simultaneously to different access points 102 using different radios. For example, the device 104 may use one radio to transmit the message 108 to the access point 102A and another radio to transmit the message 108 to the access point 102C. The transmissions may occur at the same time. The access points 102A and 102C respond to the message 108 by communicating responses 110A and 110B, respectively, to the device 104. Due to the positioning of the device 104 and obstacles in the environment, the message 108 may not reach the access points 102A and 102C at the same time. Additionally, the responses 110A and 110B may not take the same amount of time to travel to the device 104. As a result, even though the device 104 transmitted the message 108 at the same time to the access points 102A and 102C, the device 104 may not receive the responses 110A and 110B back from the access points 102A and 102C at the same time.

The device 104 determines the times at which the device 104 received the response 110A and 110B. The device 104 may approximate the location of the device 104 using the location 106A of the access point 102A and the time at which the device 104 received the response 110A from the access point 102A, a location of the device 104. The device 104 may also approximate the location of the device 104 using the location 106C of the access point 102C and the time at which the device 104 received the response 110B from the access point 102C, a location of the device 104. These determined locations, however, may include inaccuracies. To improve accuracy, the device 104 may determine a location 112 of the device 104 using the locations 106A and 106C of the access points 102A and 102C, the times at which the device 104 received the responses 110A and 110B, and/or the difference between the times (which may also be referred to as a time differential) at which the device 104 received the responses 110A and 110B. In this manner, the device 104 effectively uses a single message 108 to generate multiple samples for determining the location 112. As a result, the determined location 112 may be more accurate relative to existing ranging techniques.

FIG. 1B illustrates an example access point 102 or device 104 in the system 100 of FIG. 1A. As seen in FIG. 1B, the access point 102 and/or device 104 includes a processor 122, a memory 124, and multiple radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the access point 102 and/or device 104. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the access point 102 and/or device 104 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the access point 102 and/or device 104 may use one or more of the radios 126 for Wi-Fi communications. The access point 102 and/or device 104 may use one or more of the radios 126 to transmit messages and one or more of the radios 126 to receive messages. The access point 102 and/or device 104 may include any number of radios 126 to communicate using any number of communication technologies.

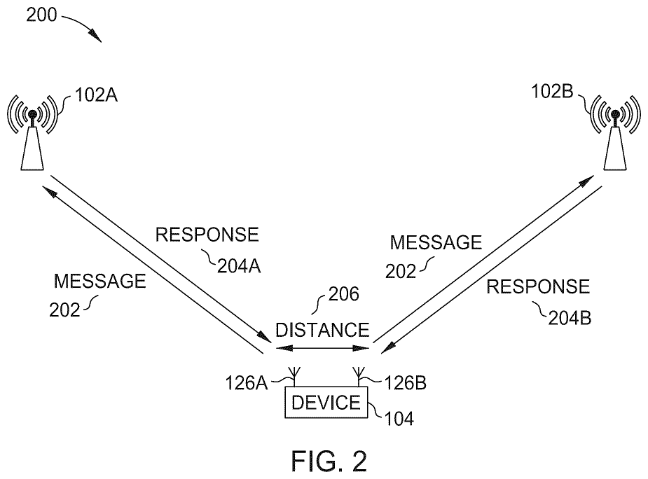

FIG. 2 illustrates an example operation 200 performed by the system 100 of FIG. 1A. As seen in FIG. 2, the device 104 includes a radio 126A and a radio 126B. The device 104 performs ranging using these radios 126A and 126B. The device 104 begins by transmitting a message 202 to the access point 102A using the radio 126A and by transmitting the message 202 to the access point 102B using the radio 126B. The device 104 may transmit the message 202 using the radios 126A and 126B simultaneously or at the same time. The access points 102A and 102B respond to the message by communicating responses 204A and 204B, respectively, to the device 104. In some embodiments, the message 202 is an initiator-to-responder (I2R) null data packet (NDP) frame, and the responses 204A and 204B are responder-to-initiator (R2I) NDP frames.

Due to the positioning of the device 104 relative to the access points 102A and 102B and due to obstacles in the environment, the message 202 may reach the access points 102A and 102B at different times. Additionally, the responses 204A and 204B may reach the device 104 at different times. The device 104 may use the locations of the access points 102A and 102B and the times at which the device 104 received the responses 204A and 204B to determine the location of the device 104.

In certain embodiments, the device 104 may determine the location of the device 104 more accurately than existing ranging techniques. Additionally, the device 104 may determine other information related to the location of the device 104. For example, the device 104 may also use the distance 206 between the radios 126A and 126B along with the locations of the access points 102A and 102B and the times at which the device 104 received the responses 204A and 204B to determine an orientation or alignment of the device 104 relative to the access points 102A and 102B.

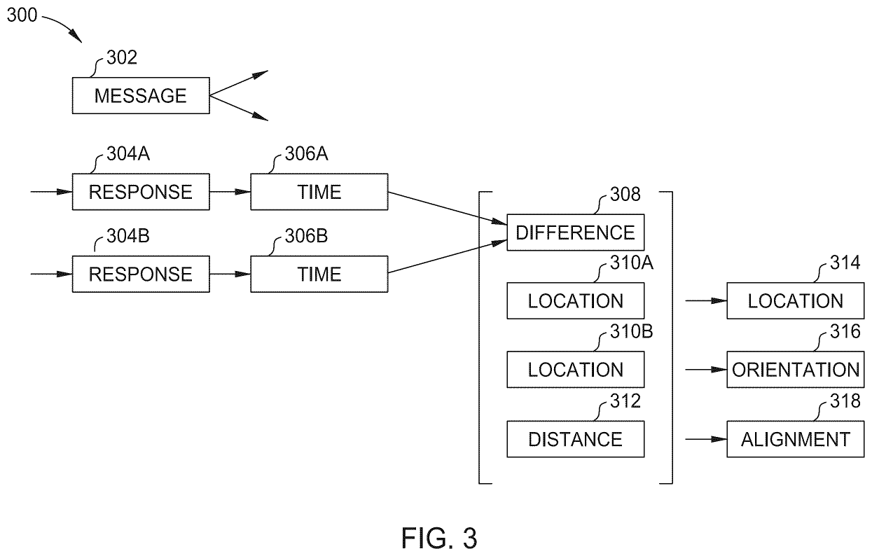

FIG. 3 illustrates an example operation 300 performed by the system 100 of FIG. 1A. Generally, a device (e.g., the device 104 shown in FIG. 1A) performs the operation 300 to determine a location of the device.

The device begins by transmitting a message 302 to multiple access points simultaneously using different radios. For example, the device may transmit the message 302 to a first access point using one radio while transmitting the message 302 to a second access point using another radio. The message 302 may be an I2R NDP frame used to measure channels used by the device and the access points.

The device may transmit the message 302 using any number of frequencies and/or channels supported by the access points. For example, if the access points are assigned to the same channel, the device may transmit the message 302 to a first access point using a frequency range in a first portion of the channel, and the device may transmit the message 302 to a second access point using a frequency range in a second portion of the channel. In this manner, the device may measure the entire channel using parallel transmissions. As another example, if the access points are assigned to adjacent channels, the device may transmit the message 302 to the first access point using a frequency range in a first channel, and the device may transmit the message 302 to the second access point using a frequency range in a second channel.

As another example, the device may support orthogonal frequency division multiple access (OFDMA). The device may also support multiple streams. As a result, the device may transmit the message 302 to even more access points to perform ranging with these access points while consuming only one frame of airtime. For example, if the device supports OFDMA 320 MegaHertz (MHz) and two streams, then the device may transmit the message 302 to eight different access points (with 4×80 MHz for each stream). In some embodiments, this process allows the device to attain sub-foot accuracy when determining the location of the device.

The device receives the responses 304A and 304B from the access points in response to the message 302. In the example of FIG. 3, the device receives the response 304A from the first access point at a time 306A and the response 304B from the second access point at a time 306B. The times 306A and 306B may be different from each other even though the device transmitted the message 302 to the first and second access points at the same time. In some embodiments, the device uses only the response 304A or 304B that was received first to determine the location of the device. For example, the device may treat the response 304A or 304B that was received first as more indicative of a communication path with line of sight (e.g., less obstructions), which may produce the more accurate location determination. The device then uses that response 304A or 304B (and not the other response) to perform ranging and to determine the location of the device.

The device may also use both responses 304A and 304B and both times 306A and 306B to determine the location of the device. In the example of FIG. 3, the device determines a difference 308 between the time 306A and the time 306B (e.g., a time differential). The difference 308 may indicate how much longer it took the device to receive a response 304 from an access point than another access point. The device also determines the locations 310A and 310B of the access points. For example, the access points may transmit the locations 310A and 310B to the device when the device connects to the access points, in the responses 304A and 304B, etc. The locations 310A and 310B may include coordinates that indicate the location of the access points. The device may also determine a distance 312 between the radios used to transmit the message 302 to the access points. The distance 312 may be programmed into the device (e.g., indicated in firmware or memory).

The device determines a location 314 of the device using the information. For example, the device may use the difference 308 and the locations 310A and 310B to determine the location 314 of the device. For example, the device may determine a first approximate location of the device using the location 310A and the time 306A. The device may also determine a second approximate location of the device using the location 310B and the time 306B. The device may then use the difference 308 to determine how to combine or complement the location approximations, which produces a more accurate location 314 of the device. For example, the device may treat the determined approximate locations as samples, and the different may indicate how the device should weight the samples when combining the samples (e.g., using a weighted average of the samples) to produce the location 314. The greater the difference 308, the greater that one approximate location may be weighted relative to the other. In this manner, the device determines a more accurate location 314 relative to other ranging techniques.

The device may also determine other information. In the example of FIG. 3, the device determines an orientation 316 of the device. For example, the device may use the times 306A and 306B, the difference 308, the locations 310A and 310B, and/or the distance 312 to determine the orientation 316. The orientation 316 may indicate in which direction the device is facing. For example, the orientation 316 may indicate that the device is facing one access points and not the other access point. The device may also use the times 306A and 306B, the difference 308, the locations 310A and 310B, and/or the distance 312 to determine an alignment 318 of the device. The alignment 318 may indicate how aligned the device is and/or the radios of the device are to the access points.

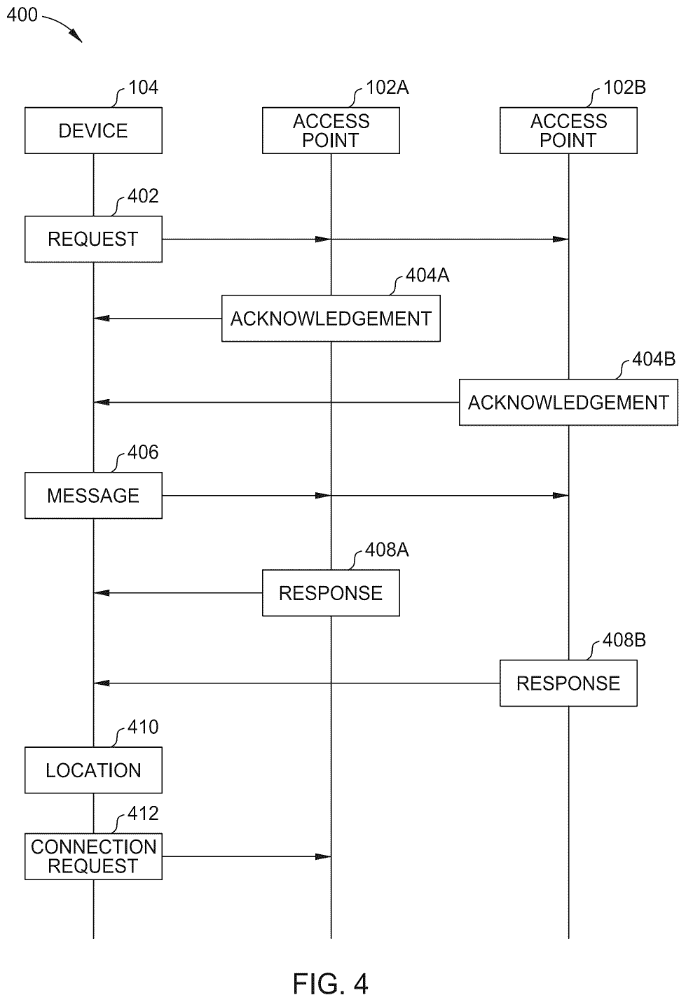

FIG. 4 illustrates an example operation 400 performed by the system 100 of FIG. 1A. as seen in FIG. 4, the access points 102A and 102B and the device 104 may perform the operation 400. By performing the operation 400, the device 104 performs ranging with the access points 102A and 102B.

The device 104 begins by transmitting a request 402 to the access points 102A and 102B. The request 402 may be a null data packet announcement (NDPA) frame that indicates that the device 104 is requesting and/or initiating ranging. For example, the NDPA frame may indicate that the device 104 is an initiating station and that the ranging is trigger based. The device 104 may transmit the request 402 simultaneously to the access points 102A and 102B using different radios of the device 104. Alternatively, the device 104 may transmit the request 402 sequentially to the access points 102A and 102B.

The access points 102A and 102B may receive the request 402 and transmit acknowledgements 404A and 404B, respectively, back to the device 104. The acknowledgements 404A and 404B may indicate to the device 104 that the access points 102A and 102B received the request 402 and that the access points 102A and 102B are ready to perform ranging with the device 104.

In some embodiments, prior to transmitting the request 402, the access points 102A and 102B and the device 104 may announce to each other (e.g., using capabilities elements) that the access points 102A and 102B and the device 104 support trigger-based ranging initiated by a device. The device 104 may communicate the request 402 only if the access points 102A and 102B have indicated that the access points 102A and 102B support trigger-based ranging initiated by the device 104.

After the device 104 receives the acknowledgements 404A and 404B, the device 104 transmits a message 406 to the access points 102A and 102B. The device 104 transmits the message 406 to the access points 102A and 102B simultaneously using different radios of the device 104. The message 406 may be an I2R NDP frame (e.g., one frame from each radio) that initiates ranging with the access points 102A and 102B. Each radio may use a frequency that is used by the respective access point 102A or 102B.

The access points 102A and 102B may receive the message 406 at different times depending on the positioning of the device 104 relative to the access points 102A and 102B. For example, if the device 104 is further away from the access point 102B than the access point 102A, then it may take the access point 102B more time to receive the message 406 than the access point 102A. The access points 102A and 102B generate and transmit responses 408A and 408B, respectively, to the device 104 in response to receiving the message 406. The responses 408A and 408B may be R2I NDP frames. Due to the positioning of the device 104, the responses 408A and 408B may take different amounts of time to travel to the device 104. As a result, the device 104 may receive the responses 408A and 408B at different times.

The device 104 uses the times at which the responses 408A and 408B are received to determine a location 410 of the device 104. For example, the device 104 may use the time of the response 408A or 408B that was received first to determine the location 410. As another example, the device 104 may use the difference between the times when the responses 408A and 408B are received to determine the location 410. In this manner, the device 104 effectively determines multiple samples of the location of the device, which may produce a more accurate location 410 relative to existing ranging techniques.

The device 104 may determine, from the location 410, that the device 104 is closer to the access point 102A than the access point 102B. In response, the device may communicate a connection request 412 to the access point 102A to connect to the access point 102A. In this manner, the device 104 may be provided a stronger connection, which improves communication and reduces packet loss.

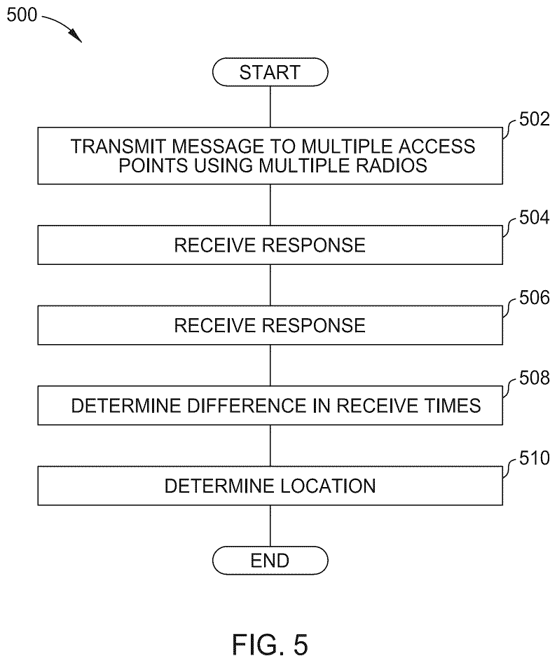

FIG. 5 is a flowchart of an example method 500 performed by the system 100 of FIG. 1A. In certain embodiments, a device (e.g., the device 104 shown in FIG. 1A) performs the method 500. By performing the method 500, the device improves accuracy of location determinations.

At 502, the device transmits a message to multiple access points using multiple radios. The device may transmit the message simultaneously to the access points using the radios. The message may be an I2R NDP frame. In this manner, the device initiates ranging with the access points at the same time.

At 504, the device receives a first response to the message from a first access point. At 506, the device receives a second response to the message from a second access point. The device may receive the first response and the second response at different times due to the positioning of the device relative to the first and second access points. The responses may be R2I NDP frames sent by the first and second access points as part of the ranging process.

At 508, the device determines a difference in receive times for the first and second responses. At 510, the device determines a location of the device. For example, the device may determine that the first response was received before the second response, and in response, use the receive time of the first response rather than the receive time of the second response to determine the location of the device. As another example, the device may determine the location of the device using the receive times for the first and second responses. The difference between the receive times may be used to determine how to weight the receive times when using both receive times to determine the locations. For example, the greater the difference, the greater one receive time may be weighted over the other.

In summary, a device 104 initiates wireless ranging with multiple access points 102 simultaneously using multiple radios. For example, the device 104 uses a first radio to transmit a message to a first access point and a second radio to transmit the message to a second access point to initiate ranging with both access points simultaneously. The device 104 then waits for the responses from the access points 102 and may receive those responses at different times. The device 104 uses the times at which the device 104 received the responses (e.g., the differential time) to determine a location of the device.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A device comprising:
a first radio;
a second radio;
one or more memories; and
one or more processors communicatively coupled to the one or more memories, the one or more processors configured to, individually or collectively:
transmit, at a first time and using the first radio, a message to a first access point;
transmit, at the first time and using the second radio, the message to a second access point different from the first access point;
receive, at a second time after the first time and from the first access point, a first response to the message;
receive, at a third time after the first time and from the second access point, a second response to the message; and
determine, based on the second time and the third time, a location of the device.

2. The device of claim 1, wherein the one or more processors are configured to, individually or collectively:
transmit, using the first radio, a request to the first access point;
transmit, using the second radio, the request to the second access point;
receive a first acknowledgement to the request from the first access point; and
receive a second acknowledgement to the request from the second access point, wherein transmitting the message to the first access point and to the second access point is in response to receiving the first acknowledgement and the second acknowledgement.

3. The device of claim 1, wherein transmitting the message to the first access point and the second access point uses a frequency range that comprises a first frequency used by the first access point and a second frequency used by the second access point.

4. The device of claim 1, wherein the one or more processors are configured to, individually or collectively, connect to the first access point based on the third time being after the second time.

5. The device of claim 1, wherein the one or more processors are configured to, individually or collectively, determine an orientation of the device based on (i) the second time and the third time and (ii) a distance between the first radio and the second radio.

6. The device of claim 1, wherein the one or more processors are configured to, individually or collectively, determine, based on the second time and the third time, that the first radio is more aligned with the first access point than the second access point.

7. The device of claim 1, wherein determining the location is further based on a location of the first access point and a location of the second access point.

8. The device of claim 1, wherein determining the location is based on a difference between the second time and the third time.

9. A method comprising:
transmitting, at a first time and using a first radio of a device, a message to a first access point;
transmitting, at the first time and using a second radio of the device, the message to a second access point different from the first access point;
receiving, at a second time after the first time and from the first access point, a first response to the message;
receiving, at a third time after the first time and from the second access point, a second response to the message; and
determining, based on the second time and the third time, a location of the method.

10. The method of claim 9, further comprising:
transmitting, using the first radio, a request to the first access point;
transmitting, using the second radio, the request to the second access point;
receiving a first acknowledgement to the request from the first access point; and
receiving a second acknowledgement to the request from the second access point, wherein transmitting the message to the first access point and to the second access point is in response to receiving the first acknowledgement and the second acknowledgement.

11. The method of claim 9, wherein transmitting the message to the first access point and the second access point uses a frequency range that comprises a first frequency used by the first access point and a second frequency used by the second access point.

12. The method of claim 9, further comprising connecting to the first access point based on the third time being after the second time.

13. The method of claim 9, further comprising determining an orientation of the method based on (i) the second time and the third time and (ii) a distance between the first radio and the second radio.

14. The method of claim 9, further comprising determining, based on the second time and the third time, that the first radio is more aligned with the first access point than the second access point.

15. The method of claim 9, wherein determining the location is further based on a location of the first access point and a location of the second access point.

16. The method of claim 9, wherein determining the location is based on a difference between the second time and the third time.

17. A non-transitory computer readable medium storing instructions that, when executed by one or more processors, causes the one or more processors to, individually or collectively:
transmit, at a first time and using a first radio of a device, a message to a first access point;
transmit, at the first time and using a second radio of the device, the message to a second access point different from the first access point;
receive, at a second time after the first time and from the first access point, a first response to the message;
receive, at a third time after the first time and from the second access point, a second response to the message; and
determine, based on the second time and the third time, a location of the device.

18. The medium of claim 17, wherein the instructions further cause the one or more processors to, individually or collectively:
transmit, using the first radio, a request to the first access point;
transmit, using the second radio, the request to the second access point;
receive a first acknowledgement to the request from the first access point; and
receive a second acknowledgement to the request from the second access point, wherein transmitting the message to the first access point and to the second access point is in response to receiving the first acknowledgement and the second acknowledgement.

19. The medium of claim 17, wherein transmitting the message to the first access point and the second access point uses a frequency range that comprises a first frequency used by the first access point and a second frequency used by the second access point.

20. The medium of claim 17, wherein determining the location is based on a difference between the second time and the third time.
